(19) United States
(12) Patent Application Publication
(10) Pub. No.: US 2016/0223313 A1
(43) Pub. Date: Aug. 4, 2016

(54) DETERMINING THE POSITION OF A MOVABLE MEASUREMENT POINT ON A MACHINE

(71) Applicant: Schwing GmbH, Herne (DE)

(72) Inventor: Reiner Vierkotten, Oberhausen (DE)

(21) Appl. No.: 14/916,366

(22) PCT Filed: Sep. 4, 2014
(86) PCT No.: PCT/EP2014/068849

§ 371 Date: Mar. 3, 2016

(30) Foreign Application Priority Data
Sep. 4, 2013 (DE) 10 2013 014 626.7

(51) Int. Cl. G01B 7/30

(52) U.S. Cl. CPC G01B 7/30

(57) ABSTRACT

The invention relates to a machine, comprising a base frame (10) and a position detection system (4) for determining the position of at least one measurement point that can be moved in relation to the base frame (10) in two or three dimensions, in particular a mast tip (15) of an articulated mast (10a) having a plurality of mast segments (11, 12, 13, 14) articulated to each other, wherein the position detection system (4) comprises a plurality of at least three transmitting/receiving units (A, B, C, D, E) and an evaluating unit (3) which is connected to the transmitting/receiving units (A, B, C, D, E) and is designed to evaluate measurement signals of the transmitting/receiving units (A, B, C, D, E) and to derive the actual position of the measurement point from the measurement signal. The problem addressed by the invention is that of providing a machine for which the position of a measurement point that can be moved in two or three dimensions can be determined simply and with the highest possible accuracy. This problem is solved in that the transmitting/receiving units (A, B, C, D, E) are designed to communicate with each other and to produce a measurement signal therefrom, from which measurement signal the distance between a pair of the transmitting/receiving units (A, B, C, D, E) can be derived, wherein the evaluating unit (3) is designed to derive the actual position of the measurement point from the measurement signals by triangulation.

### CROSS-REFERENCE TO RELATED APPLICATION(S)

This application is a national phase application of PCT Application No. PCT/EP2014/068849, internationally filed Sep. 4, 2014, which claims the benefit of priority to German Application No. 10 2013 014 626.7, filed Sep. 4, 2013, all of which are herein incorporated by reference in their entirety.

The invention relates to a machine, comprising a base frame and a position detection system for determining the position of at least one measurement point that can be moved in relation to the base frame in two or three dimensions, in particular a mast tip of an articulated mast having a plurality of mast segments articulated to each other, wherein the position detection system comprises a plurality of at least three transmitting/receiving units and an evaluating unit which is connected to the transmitting/receiving units and is designed to evaluate measurement signals of the transmitting/receiving units and to derive the actual position of the measurement point from the measurement signals.

An example for such a machine is a large-size manipulator, e.g. a mast of a stationary or movable concrete pump, a crane, an elevating platform or the like.

For a concrete pump, for example, an articulated mast is provided which is hinged to a swivel bogie preferably pivotable about a vertical axis and having at least three mast segments which can be swivelled versus the swivel bogie or a neighbouring mast segment in limited extent about horizontal articulated axes parallel to each other by means of one driving aggregate each. The articulated mast is operated by an operator who is responsible for positioning the mast tip of the articulated mast (and/or of the end hose mounted there), using a remote control device. To this effect, the operator has to actuate each of the rotatory degrees of freedom of the articulated mast via the pertinent driving aggregates (hydraulic drives) while moving the articulated mast within the available workspace, considering relevant marginal construction site conditions. This single axis actuation is afflicted with a disadvantage in that one positioning possibility is allocated to each articulation of the articulated mast and to the swivel bogie so that operation becomes confusing and cumbersome.

For ease of handling in this regard, a so-called single-lever control was proposed, in which the position of the mast tip (and/or of the end hose) can be controlled directly by the operator. The positioning possibilities of the remote control are directly allocated to the coordinates of the mast tip in space so that the number of positioning possibilities is accordingly reduced as compared with the conventional solution.

The single-lever control calls for sensorically detecting the position of each individual mast segment and actuating the driving aggregates of the mast individually subject to the operator's control commands in order to control the position of the mast tip accordingly. To this effect, EP 1 537 282 B1, for example, proposes a control facility that actuates an articulated mast in accordance with a defined path/swivel characteristics, wherein earth-fixed torsion angles are recorded by geodetic angle sensors arranged at the mast segments in order to be able to derive the relative angles of articulation between the individual mast segments. In this manner, the angle sensors can detect the inclination of each mast segment relative to the vertical. A complete position detection is thus provided to realize a single-lever control.

It is the object to provide a machine with which a position detection of a measurement point relocatable in two or three dimensions is feasible in a simple and most exactly possible manner.

This object is achieved by the present invention, proceeding from a machine of the initially indicated kind in such a manner that the transmitting/receiving units are designed to communicate among each other and thereby to generate a measurement signal from which the distance between two each of the transmitting/receiving units can be derived, whereby the evaluating unit is designed for deriving the actual position of the measuring point from the measuring signals by triangulation.

The invention proposes that the transmitting/receiving units communicate with each other and measure the distance between two transmitting/receiving units each. From the distance measuring signals, it is then easily possible to derive the position of the measurement point by triangulation by means of the evaluating unit. Expediently, one of the transmitting/receiving units is situated in the measurement point or in a defined position relative to the measurement point. Furthermore expediently, one or two of the transmitting/receiving units are arranged on the base frame at one and/or two known reference positions. In the sense of the invention, triangulation should be understood to be an evaluating procedure in which the unknown position of one of the transmitting/receiving units is calculated on the basis of the known positions of at least another two transmitting/receiving units.

This can be utilized with advantage for the position detection of the mast tip to realize the afore-mentioned single-lever control. Accordingly, it is in particular not required to take a measurement at each single mast segment in order to derive on this basis the position of the mast tip. In the simplest case, it is sufficient to arrange a transmitting/receiving unit at the mast tip (or in a fixed defined geometric position relative to the mast tip), wherein at least another two transmitting/receiving units are arranged on the base frame at firmly assigned and thus known reference positions.

The inventive position determination can also be utilized with advantage for (redundant) detection of movements, vibrations and/or deflections of the articulated mast or individual mast segments. For example, a deviation of the real mast position from a mast position determined by angle measurement by means of one or several angle sensors can be ascertained in this manner. In a preferred embodiment, the inventive machine accordingly comprises additional angle sensors, which for example determine the relative angle of articulation of the mast segments.

The distances between the transmitting/receiving units can be measured in an actually known manner by measuring the strength (amplitude), phase and/or run-time of communication signals exchanged between transmitting/receiving units.

A transmitting/receiving unit in the sense of the invention is inventively designed (i) to transmit or (ii) to receive or (iii) to transmit and to receive communication signals. Accordingly, the transmitting/receiving units can communicate with each other in wireless mode and additionally as an option in wired mode, too. For example, communication can be realized via radio, ultrasonics or optically, in particular via infrared radiation. The determination of distances can be advantageously realized, for example, by evaluating run-time differences or signal strength differences between communication signals exchanged in wireless and in wired mode, possibly considering the transmission medium (usually air). Furthermore, a cable connection can be utilized to supply energy to the transmitting/receiving units and/or to control and synchronize communication between transmitting/receiving units.

Preferably, the evaluating unit of the inventive machine is designed to execute the position determination based on measured distances and another measuring variable, in particular a measured angle of rotation or inclination. To this effect, the position detection system then expediently comprises a suitable sensor, for example an angle sensor. To be regarded as an angle of rotation is particularly an angle of a relative rotation about a rotational axis of an articulation (for example the rotational axis of the swivel bogie of the articulated mast). The angle of inclination is the absolute angle of a mast segment versus a predefined plane, the horizontal plane, in particular.

With another preferred embodiment, the evaluating unit is designed to derive a signal from the temporal change of at least one of the measurement signals of the transmitting/receiving units, which signal is fed for vibration dampening to an actuator connected to the evaluating unit. In other words, the position detection system is designed to detect vibrations of the mast structure and to utilize the vibration measurement values for vibration dampening. Vibrations of this kind may occur particularly with concrete pumps because of the pulsating concrete delivery stream and may even entail dangerous movements of the end hose. Inventively, such vibrations can be suppressed by a mast dampening derived from the position measurement. For example, to this effect, the control valves of the hydraulic drive cylinders of the articulated mast are loaded with a dampening signal which is derived from the vibration signal.

To realize the afore-mentioned single-lever control device, a control device can advantageously be provided which comprises a processor linked to the evaluating unit of the position detection system and designed to compare actual position data transmitted from the evaluating unit with a definable design position and, in case of a deviation of the actual position from the design position, to activate an actuator for relocating the measurement point. Any construction machine, in particular a stationary or movable concrete pump, can be equipped with such a control device, wherein the actuator(s) may correspond to those actuators which a construction machine usually is equipped with, for example hydraulic drive aggregates of the articulated mast and the pivot drive of the swivel bogie.

With a preferred embodiment, one of the transmitting/receiving units is arranged at a firmly assigned position on the base frame, for example at the chassis or swivel bogie of the articulated mast of a truck-mounted concrete pump, wherein at least another one of the transmitting/receiving units is arranged at a mast segment, for example the first mast segment of the articulated mast, and wherein at least another one of the transmitting/receiving units is arranged at the mast tip, i.e. in the measurement point or in a firmly assigned position relative to the measurement point. Hereby, a position determination can be accomplished at minimum expenditure. With this embodiment, the evaluating unit can realize at least a two-dimensional position determination of the mast tip of the mast, considering the inclination angle of the mast segment at which one of the transmitting/receiving units is arranged.

If at least two transmitting/receiving units are stationarily arranged on the base frame and if at least another transmitting/receiving unit is arranged at the mast tip of the mast, then the evaluating unit can realize a three-dimensional position determination of the mast tip, in particular by inclusion of the rotational angle of the mast segment linked (via the swivel bogie) to the base frame.

With a feasible embodiment, the inventive machine which may be, for example, a construction machine such as a crane or a truck-mounted concrete pump, comprises one or several laterally extensible supports designed to prevent machine tipping. A transmitting/receiving unit can be arranged at one support, at several supports or at each support. Preferably, the transmitting/receiving units are arranged each at a point lying far outside on the relevant support. By position determination of the transmitting/receiving units mounted on the supports, it can be ascertained whether the supports have been extended, for example before a boom of the machine is actuated. A safety system can be realized in this manner that prevents operation of the boom as long as the supports have not been extended, or that restricts operation of the boom to an area in which a safe support is assured. This safety system can be utilized redundantly to another conventional system that is provided for determining the position of supports.

Practical examples of the invention are described in the following by way of drawings, where:

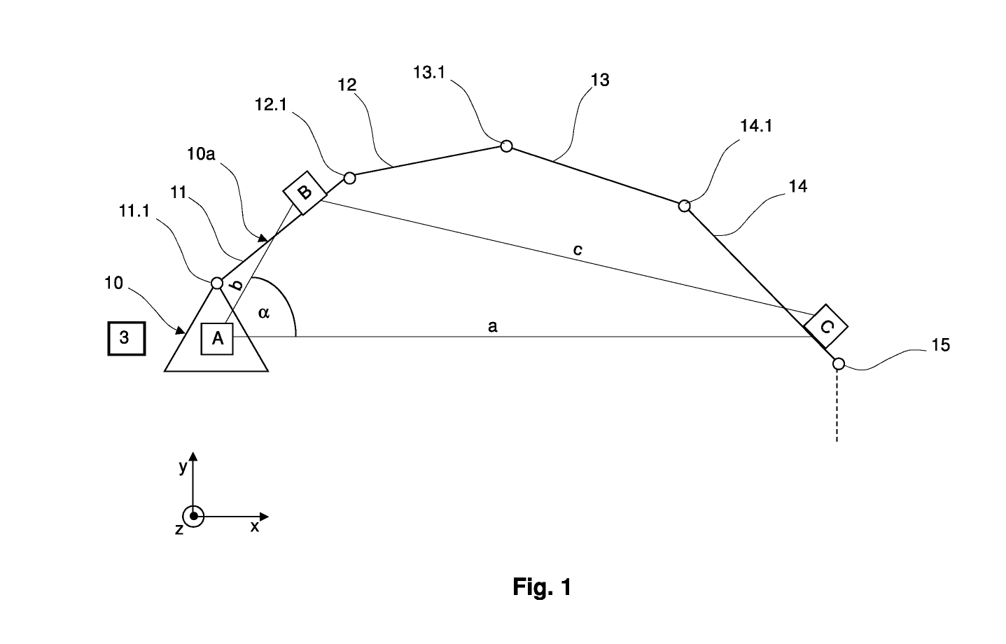

FIG. 1 in a side view in schematic representation shows an articulated mast with a position detection system for a two-dimensional measurement of the position of a mast tip in accordance with a practical example of the invention;

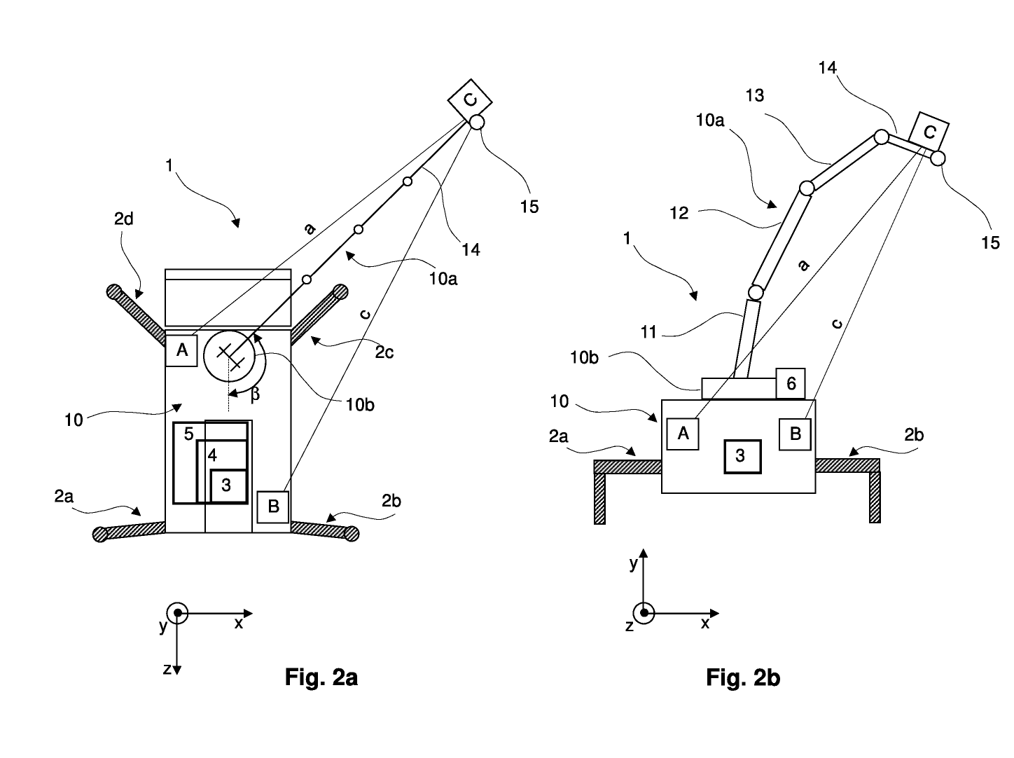

FIG. 2a in a plan view in schematic representation shows a construction vehicle with a position detection system for a three-dimensional determination of the position of a mast tip in accordance with another practical example of the invention;

FIG. 2b in a side view in schematic representation shows the arrangement in accordance with FIG. 2a;

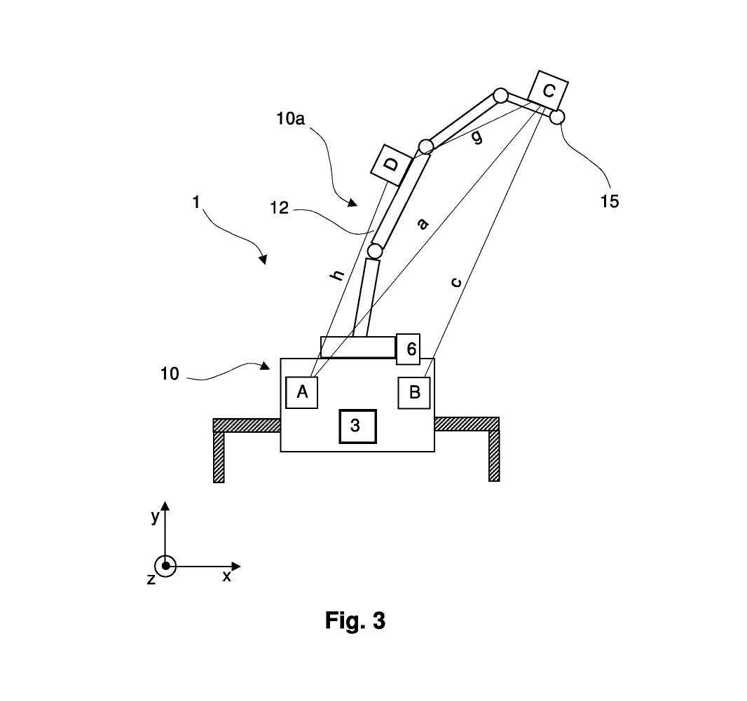

FIG. 3 in a side view in schematic representation shows a construction vehicle with a position detection system for a three-dimensional detection of the position of a mast tip as well as of an individual mast segment in accordance with another practical example of the invention;

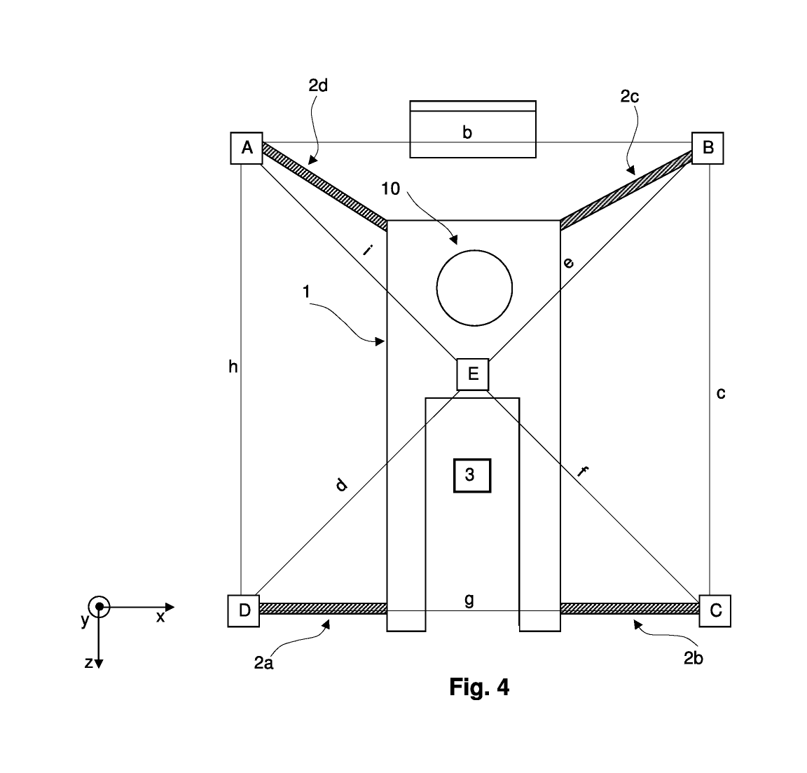

FIG. 4 in a plan view in schematic representation shows a construction vehicle with a position detection system in accordance with another practical example of the invention; and

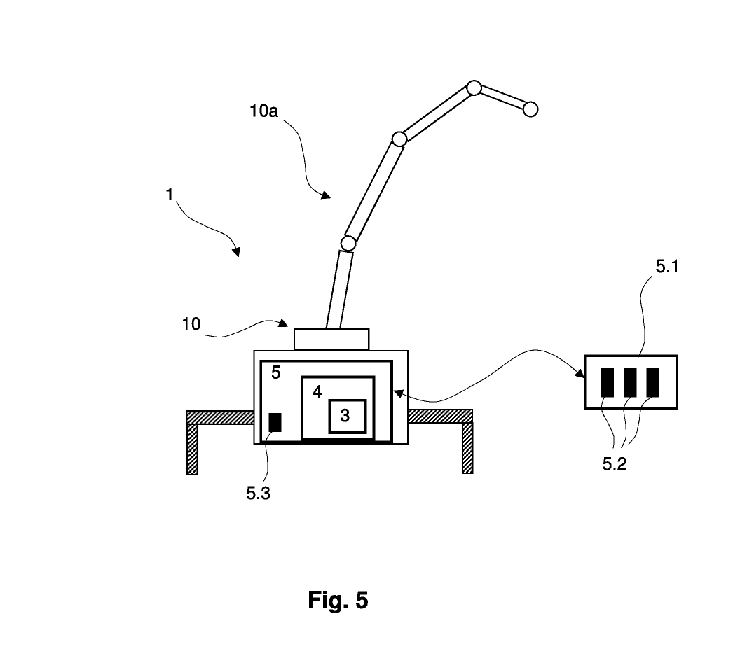

FIG. 5 in a side view in schematic representation shows a vehicle with a control device in accordance with another practical example of the invention.

Illustrated in FIG. 1 is a base frame 10 of a machine, an articulated mast 10a being hinged to the said base frame, the said articulated mast comprising four mast segments 11, 12, 13, 14 and a mast tip 15 located at the end of the fourth mast segment 14. The mast segments 11, 12, 13, 14 are pivotably coupled to each other in articulations 11.1, 12.1, 13.1, 14.1. Arranged on the base frame 10 is a transmitting/receiving unit A, there being another transmitting/receiving unit B arranged on the first mast segment 11, and there being another transmitting/receiving unit C arranged on the fourth mast segment 14. The transmitting/receiving unit C is arranged in the area of the mast tip 15.

In the illustrated mast position, the transmitting/receiving units A and B have a distance (b) relative to each other, and the distance of the transmitting/receiving units A and C from each other amounts to (a), whereas the transmitting/receiving units B and C are arranged at a distance (c) from each other. All distances (a), (b), (c) are variable when relocating the mast tip 15.

The transmitting/receiving units A, B, C communicate with each other via an exchange of signals (e.g. radio signals). Accordingly, for example, the transmitting/receiving unit C emits a signal which is received by the transmitting/receiving units A and B, with the distances (a) and (c) being derivable from the relevant run-time of the signal. The transmitting/receiving unit A additionally receives a signal emitted from the transmitting/receiving unit B in order to be able to determine the distance (b), too. Communication can also be accomplished bi-directionally between pairs of transmitting/receiving units A, B, C in order to be able to determine the distances redundantly and thus more reliably and more precisely. The three distances (a), (b), (c) unambiguously determine the triangle with the corner points A, B, C. For example, by additional inclusion of the angle of inclination of the first mast segment 11, the position of the triangle in space and thus the (two-dimensional) position of the mast tip 15 can also be determined. In this sense, the position determination in accordance with the invention is accomplished by triangulation. The angle of inclination can be determined, for example, by means of an angular rotation sensor (not illustrated) arranged in the first articulation 11.1. Position determining is executed by an evaluating unit 3 which is linked to the transmitting/receiving units A, B, C, no matter whether in wired mode and/or in wireless mode. For clarity's sake, the relevant link is not illustrated here.

FIG. 2a shows a vehicle 1 comprising a base frame 10 and four supports 2a, 2b, 2c, 2d, wherein an articulated mast 10a is mounted on base frame 10, the said articulated mast having four mast segments 11, 12, 13, 14 and a mast tip 15. Arranged on the base frame 10 and/or vehicle 1 are two transmitting/receiving units A and B at predefined, firmly assigned positions, and another transmitting/receiving unit C is arranged at the mast tip 15 or in the area of mast tip 15 at a defined, firmly assigned distance to mast tip 15. An angular sensor 6 in form of an angular rotation sensor (illustrated in FIG. 2b) detects an angle of rotation β of a swivel bogie 10b of the articulated mast 10a about a vertical axis. Distances (a) and (c) can hereby be determined, and the position of mast tip 15 relative to all three dimensions can be unambiguously determined. The transmitting/receiving units A, B, and C are linked to an evaluating unit 3 which is part of the position detection system 4. In the illustrated practical example, this in turn is a component of a control device 5 to control the articulated mast 10a. To this effect, the control device 5 activates the drive aggregates (hydraulic cylinders not illustrated) of the articulated mast 10a as well as the pivot drive (not illustrated) of swivel bogie 10b.

FIG. 2b illustrates the articulated mast 10a in a side view.

FIG. 3 illustrates a vehicle 1 according to the practical example shown in FIG. 2b, but this practical example differs in the number of transmitting/receiving units. At least another one transmitting/receiving unit D is arranged at one of the mast segments 12, and by means of the further transmitting/receiving unit D, further distances can be determined, in particular a distance (g) between the transmitting/receiving units C and D as well as a distance (h) between the transmitting/receiving units A and D. By inclusion of the known geometry of articulated mast 10a, the position of all mast segments can be determined. These informative data can be realized for automatic anti-collision protection, e.g. by specifying maximal x, y, and/or z coordinates not to be exceeded for individual mast segments or for the mast as a whole.

FIG. 4 illustrates a vehicle 1 with an arrangement of five transmitting/receiving units A, B, C, D and E, in which arrangement at least eight distances can be determined, in particular the distances b, c, d, e, f, g, h and i, with distance d existing between transmitting/receiving units D and E, distance e existing between transmitting/receiving units B and E, distance f existing between transmitting/receiving units C and E, and distance i existing between transmitting/receiving units A and E. Transmitting/receiving units A to D each are arranged at one of the laterally extensible supports 2a, 2b, 2c, 2d, so that it can be ascertained by way of the inventive position detection system whether supports 2a, 2b, 2c and 2d have been extended, i.e. that the vehicle 1 is secured against tipping. The position detection can be provided complementary to other conventional systems for recognition of the status of extension of supports 2a, 2b, 2c, 2d in order to increase operational safety.

FIG. 5 illustrates a vehicle 1 with a control device 5 which inventively comprises a position detection system 4 and an evaluating unit 3 as well as a single-lever operating element 5.1 and a processor 5.2. For example, the single-lever operating element 5.1 is integrated by means of one or several control levers (joysticks) 5.2 in a remote control which by means of the illustrated radio path or cable connection is linked to the control device 5. By means of control levers 5.2, the articulated mast can be controlled, for example in a polar coordinate system or in a Cartesian coordinate system. The term “single-lever operating element” is attributable to the fact that the mast is controlled with one control lever 5.2 each, for example in the Cartesian coordinate system in x-direction (forward/backward), in y-direction (sideward) or in z-direction (upward/downward). In the polar coordinate system, control is accomplished analogously with several control levers. It is also conceivable to control several directions with a single control lever 5.2.

The control device 5 controls actuators (not illustrated), e.g. control valves of hydraulic drives of articulated mast 10a. The position detection system 4 supplies actual position data of articulated mast 10a via the evaluating unit 3 to processor 5.3 which performs a design-to-actual value comparison and which in case of a deviation from the design position controls the actuators in such a manner that the design position of mast tip 15 which is predetermined by means of control levers 5.2 is automatically approached and maintained.

In the practical examples shown here, the evaluating unit 3 can be designed to derive a signal from the temporal course of at least one of the measurement signals from transmitting/receiving units A, B, C, D, E, which signal is fed for vibration dampening to the drive aggregates of articulated mast 10a that are connected to the evaluating unit 3. To this effect, for example, the control valves of the hydraulic drive cylinders of articulated mast 10a are loaded with signals suitably derived from the measurement signals of transmitting/receiving units A, B, C, D, E. Transmitting/receiving units A, B, C, D, E are thus utilized to detect vibrations of the mast structure, in particular with concrete pumps due to the pulsating concrete delivery stream, and to utilize the vibration measurement values for vibration dampening. These vibrations are accordingly suppressed by a dampening of the articulated mast 10a which is derived from the position measurement.

### LIST OF REFERENCE SIGNS

### List of Reference Signs

1 Vehicle
2a, 2b, 2c, 2d Supports
3 Evaluating unit
4 Position detection system
5 Control device
5.1 Single-lever operating element
5.2 Control lever(Joystick)
5.3 Processor
6 Angle sensor
10 Base frame
10a Articulated mast
10b Swivel bogie
11 First mast segment
11.1 First articulation
12 Second mast segment
12.1 Second articulation
13 Third mast segment
13.1 Third articulation
14 Fourth mast segment
14.1 Fourth articulation
15 Mast tip
A First transmitting/receiving unit (node)
B Second transmitting/receiving unit (node)
C Third transmitting/receiving unit (node)
D Fourth transmitting/receiving unit (node)
E Fifth transmitting/receiving unit (node)
a Distance between the first and the third transmitting/receiving unit
b Distance between the first and the second transmitting/receiving unit
c Distance between the second and the third transmitting/receiving unit
d Distance between the fourth and the fifth transmitting/receiving unit
e Distance between the second and the fifth transmitting/receiving unit
f Distance between the third and the fifth transmitting/receiving unit
g Distance between the third and the fourth transmitting/receiving unit
h Distance between the first and the fourth transmitting/receiving unit
i Distance between the first and the fifth transmitting/receiving unit
α Angle
β Rotation angle of the mast, in particular about a vertical axis

1. A machine, comprising a base frame (10) and a position detection system (4) for determining the position of at least one measurement point that can be moved in relation to the base frame (10) in two or three dimensions, in particular a mast tip (15) of an articulated mast (10a) having a plurality of mast segments (11, 12, 13, 14) articulated to each other, wherein the position detection system (4) comprises a plurality of at least three transmitting/receiving units (A, B, C, D, E) and an evaluating unit (3) which is connected to the transmitting/receiving units (A, B, C, D, E) and is designed to evaluate measurement signals of the transmitting/receiving units (A, B, C, D, E) and to derive the actual position of the measurement point from the measurement signals,
characterized in that the transmitting/receiving units (A, B, C, D, E) are designed to communicate with each other and to produce a measurement signal therefrom, from which measurement signal the distance between a pair of the transmitting/receiving units (A, B, C, D, E) can be derived, wherein the evaluating unit (3) is designed to derive the actual position of the measurement point from the measurement signals by triangulation.

2. A machine according to claim 1, characterized in that the measurement signal is a run-time, a phase or a strength of a communication signal exchanged between two units each of the transmitting/receiving units (A, B, C, D, E).

3. A machine according to claim 1 or 2, characterized in that the position detection system (4) comprises an angle sensor (6) which is designed to detect a rotation and/or inclination angle (α, β), in particular about a stationary axis, wherein the evaluating unit (3) is designed to determine the position of the measurement point by inclusion of the rotation and/or inclination angle (α, β).

4. A machine according to any of the preceding claims, characterized in that the evaluating unit (3) is designed to derive a vibration signal from the temporal change of at least one of the measurement signals of the transmitting/receiving units, which vibration signal is fed to an actuator (5.3) connected to the evaluating unit (3) for vibration dampening.

5. A machine according to any of the preceding claims 1 to 4, characterized by a control device (5) comprising a processor (5.2) which is linked to the evaluating unit (3) of the position detection system (4) and designed to compare actual position data transmitted from the evaluating unit (3) with a definable design position and to activate at least one actuator (5.3) for relocating the measurement point in case of a deviation of the actual position from the design position.

6. A machine according to any of the preceding claims 1 to 5, characterized in that at least one of the transmitting/receiving units (A, B, C, D, E) is arranged at a fixed defined position on the base frame (10), wherein at least another one of the transmitting/receiving units (A, B, C, D, E) is arranged at a mast segment (11, 12, 13, 14) of the articulated mast (10a), and wherein at least another one of the transmitting/receiving units (A, B, C, D, E) is arranged at the mast tip.

7. A machine according to any of the preceding claims 1 to 6, characterized in that at least two transmitting/receiving units (A, B, C, D, E) each are arranged at a firmly assigned position on the base frame (10), wherein at least another transmitting/receiving unit (A, B, C, D, E) is arranged at the mast tip of the articulated mast (10a).

8. A machine according to any of the preceding claims 1 to 7, characterized in that at least one of the transmitting/receiving units (A, B, C, D, E) is arranged on a support (2a, 2b, 2c, 2d) which can be extended laterally from the base frame (10) and which is designed to secure the machine against tipping.

9. A machine according to any of the preceding claims 1 to 8, characterized in that the machine is a mobile or a stationary concrete pump.
